(19) United States
(12) Patent Application Publication
(10) Pub. No.: US 2025/0330882 A1
(43) Pub. Date: Oct. 23, 2025

(54) METHOD AND DEVICE FOR SUPPORTING HANDOVER BETWEEN DIFFERENT RATS THROUGH CORE ENHANCEMENT

(71) Applicant: Samsung Electronics Co., Ltd., Suwon-si (KR)

(72) Inventors: Kyoungmin PARK, Suwon-si (KR); Youngbum KIM, Suwon-si (KR)

(21) Appl. No.: 19/185,011

(22) Filed: Apr. 21, 2025

(30) Foreign Application Priority Data
Apr. 19, 2024 (KR) 10-2024-0052855

(51) Int. Cl. H04W 36/00; H04W 36/14; H04W 36/30

(52) U.S. Cl. CPC H04W 36/00698; H04W 36/0058; H04W 36/00835; H04W 36/144; H04W 36/304

(57) ABSTRACT

The disclosure relates to a 5G or 6G communication system for supporting a higher data transfer rate than a 4G communication system such as LTE. According to an embodiment, a method performed by a user equipment (UE) in a communication system includes receiving, from a serving cell, candidate cell configuration information on at least one candidate cell associated with inter radio access technology (RAT) handover, wherein the serving cell corresponds to a first RAT and the at least one candidate cell corresponds to a second RAT different from the first RAT and the candidate cell configuration information includes measurement configuration information associated with the at least one candidate cell and report configuration information associated with the at least one candidate cell; identifying that measurement for the second RAT is triggered; performing the measurement based on the measurement configuration information; transmitting, to the serving cell, a report for the measurement based on the report configuration information; and performing operations associated with the inter RAT handover.

### CROSS-REFERENCE TO RELATED APPLICATIONS

This application is based on and claims priority under 35 U.S.C. § 119 to Korean Patent Application No. 10-2024-0052855, filed on Apr. 19, 2024, in the Korean Intellectual Property Office, the disclosure of which is herein incorporated by reference in its entirety.

### BACKGROUND

### 1. Field

The disclosure relates generally to a wireless communication system and, more specifically, is to support fast inter-radio access technology (RAT) handover of a terminal capable of communicating with multiple RATs. The disclosure provides mobility between independent RATs and/or inter-RAT mobility through enhancement of a core (or core network (CN)).

### 2. Description of Related Art

A review of the development of wireless communication from generation to generation shows that the development has mostly been directed to technologies for services targeting humans, such as voice-based services, multimedia services, and data services. It is expected that connected devices which are exponentially increasing after commercialization of 5th generation (5G) communication systems will be connected to communication networks. Examples of things connected to networks may include vehicles, robots, drones, home appliances, displays, smart sensors installed in various infrastructures, construction machines, factory equipment, and the like. Mobile devices are expected to evolve into various formfactors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as “beyond-5G” systems.

6G communication systems, which are expected to be implemented approximately by 2030, will have a maximum transmission rate of tera (1,000 giga)-level bps and a radio latency of 100 μ sec. That is, 6G communication systems will be 50 times as fast as 5G communication systems and have the 1/10 radio latency thereof.

In order to accomplish such a high data transmission rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, a technology capable of securing the signal transmission distance (that is, coverage) will become more crucial. It is necessary to develop, as major technologies for securing the coverage, multiantenna transmission technologies including radio frequency (RF) elements, antennas, novel waveforms having a better coverage than OFDM, beamforming and massive multi-input multi-output (MIMO), full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the frequency efficiencies and system networks, the following technologies have been developed for 6G communication systems: a full-duplex technology for enabling an uplink (UE transmission) and a downlink (node B transmission) to simultaneously use the same frequency resource at the same time; a network technology for utilizing satellites, high-altitude platform stations (HAPS), and the like in an integrated manner; a network structure innovation technology for supporting mobile nodes B and the like and enabling network operation optimization and automation and the like; a dynamic spectrum sharing technology though collision avoidance based on spectrum use prediction, an artificial intelligence (AI)-based communication technology for implementing system optimization by using AI from the technology design step and internalizing end-to-end AI support functions; and a next-generation distributed computing technology for implementing a service having a complexity that exceeds the limit of UE computing ability by using super-high-performance communication and computing resources (mobile edge computing (MEC), clouds, and the like). In addition, attempts have been continuously made to further enhance connectivity between devices, further optimize networks, promote software implementation of network entities, and increase the openness of wireless communication through design of new protocols to be used in 6G communication systems, development of mechanisms for implementation of hardware-based security environments and secure use of data, and development of technologies for privacy maintenance methods.

It is expected that such research and development of 6G communication systems will enable the next hyper-connected experience in new dimensions through the hyper-connectivity of 6G communication systems that covers both connections between things and connections between humans and things. Specifically, it is expected that services such as truly immersive XR, high-fidelity mobile holograms, and digital replicas could be provided through 6G communication systems. In addition, with enhanced security and reliability, services such as remote surgery, industrial automation, and emergency response will be provided through 6G communication systems, and thus these services will be applied to various fields including industrial, medical, automobile, and home appliance fields.

The above information is presented as background information only to assist with an understanding of the disclosure. No determination has been made, and no assertion is made, as to whether any of the above might be applicable as prior art with regard to the disclosure.

### SUMMARY

The disclosure provides a method of supporting control of mobility between independently operating RATs by only adding a core function of a new network without enhancing an network. In addition, the disclosure provides a network and terminal operation for supporting superior performance compared to inter-RAT mobility.

The technical subjects pursued in the disclosure may not be limited to the above-mentioned technical subjects, and other technical subjects which are not mentioned may be clearly understood from the following descriptions by those skilled in the art to which the disclosure pertains.

In order to achieve the tasks described above, the disclosure includes transferring, by a first RAT, configuration information and control information required for control or measurement of the first RAT and a second RAT through a connection between the first RAT and a terminal, performing, by the terminal, configuration application and signal measurement for the first RAT and the second RAT, reporting, by the terminal, a measurement for each of the RATs to a network through the connection with the first RAT, and performing, by the terminal, a handover through control of each of the first RAT and the second RAT.

In order to achieve the tasks described above, the disclosure provides a method of processing a control signal in a wireless communication system, the method including receiving a first reference signal transmitted from a transmitter, obtaining channel information, based on the received first control reference signal, transferring the information to the transmitter, applying a transmission technique, based on the information, transferring control information about the transmission technique to a receiver, and performing a receiver operation, based on the control information.

According to an embodiment, a method performed by a user equipment (UE) in a communication system includes: receiving, from a serving cell, candidate cell configuration information on at least one candidate cell associated with inter radio access technology (RAT) handover, wherein the serving cell corresponds to a first RAT and the at least one candidate cell corresponds to a second RAT different from the first RAT and the candidate cell configuration information includes measurement configuration information associated with the at least one candidate cell and report configuration information associated with the at least one candidate cell; identifying that measurement for the second RAT is triggered; performing the measurement based on the measurement configuration information; transmitting, to the serving cell, a report for the measurement based on the report configuration information; and performing operations associated with the inter RAT handover.

According to an embodiment, wherein the measurement is triggered: from the serving cell based on an implicit indication corresponding to the first configuration being received or (ii) an explicit indication to trigger the measurement being received from the serving cell, or by the UE autonomously in case that a second configuration to allow the UE to trigger the measurement autonomously is received from the serving cell.

According to an embodiment, wherein the receiving the candidate cell configuration information, the identifying that measurement for the second RAT is triggered, the performing the measurement, and the transmitting the report is in an operation among a plurality of operations associated with the inter RAT handover, wherein in case that one of first predetermined conditions to perform a next operation is satisfied during an operation, the UE performs the next operation, wherein in case that one of second predetermined conditions to perform a previous operation is satisfied during an operation, the UE performs the previous operation, wherein the first predetermined conditions are defined for each operation and include: a radio resource control (RRC) configuration is received, an explicit indication to perform the next operation is received, and the UE determines to perform the next operation based on a configured condition, and wherein the second predetermined conditions are defined for each operation and include: a timer configured for an operation is expired.

According to an embodiment, wherein the plurality of operations include: performing searching a target RAT for the inter RAT handover in case that a first predetermined condition to perform searching the target RAT is satisfied; after transmitting the report, establishing dual connectivity (DC) for a master cell group (MCG) corresponding to the first RAT and a secondary cell group (SCG) corresponding to the second RAT in case that a first predetermined condition to perform the establishing the DC is satisfied, wherein the SCG corresponding to the second RAT includes a candidate cell; performing communication in case that a first predetermined condition to perform the communication is satisfied; switching the MCG corresponding to the first RAT to an SCG corresponding to the first RAT and the SCG corresponding to the second RAT to an MCG corresponding to the second RAT in case that a first predetermined condition to switch is satisfied; and releasing the SCG corresponding to the first RAT in case that a first predetermined condition to release the SCG is satisfied.

According to an embodiment, wherein the communication includes reception of downlink user data duplicated on the MCG corresponding to the first RAT and the SCG corresponding to the second RAT, and wherein downlink user data is received on the MCG corresponding to the second RAT and not received on the SCG corresponding to the first RAT after the switching.

According to an embodiment, wherein after the DC is established, the SCG corresponding to the second RAT is inactive, before performing the communication, wherein: user data is not communicated on the inactive SCG corresponding to the second RAT; a downlink reference signal (RS) is available to be received on the inactive SCG corresponding to the second RAT; and an uplink RS is available to be transmitted on the inactive SCG corresponding to the second RAT subject to a UE capability in case that an indication to transmit the uplink RS on the inactive SCG corresponding to the second RAT is received or in case that the first RAT corresponds to a 5th generation (5G) technology and the second RAT corresponds to a 6G technology.

According to an embodiment, wherein in case that a second predetermined condition for the operation including the receiving the candidate cell configuration information, the identifying that measurement for the second RAT is triggered, the performing the measurement, and the transmitting the report is satisfied, the candidate cell configuration information is terminated and the UE fallbacks to perform searching the target RAT, wherein in case that a second predetermined condition for the establishing the DC is satisfied, the UE fallbacks to perform one of searching the target RAT or the operation including the receiving the candidate cell configuration information, the identifying that measurement for the second RAT is triggered, the performing the measurement, and the transmitting the report, wherein in case that a second predetermined condition for the performing the communication is satisfied, the UE fallbacks to perform one of searching the target RAT, the operation including the receiving the candidate cell configuration information, the identifying that measurement for the second RAT is triggered, the performing the measurement, and the transmitting the report, or the establishing the DC, wherein in case that a second predetermined condition for the switching is satisfied, the UE fallbacks to perform one of searching the target RAT, the operation including the receiving the candidate cell configuration information, the identifying that measurement for the second RAT is triggered, the performing the measurement, and the transmitting the report, the establishing the DC, or the performing the communication, and wherein in case that a second predetermined condition for the releasing is satisfied, the UE fallbacks to perform one of searching the target RAT, the operation including the receiving the candidate cell configuration information, the identifying that measurement for the second RAT is triggered, the performing the measurement, and the transmitting the report, the establishing the DC, the performing the communication, or the switching.

According to an embodiment, wherein at least one of the first predetermined conditions corresponds to link quality for at least one of the first RAT, the second RAT, the target RAT, or a cell.

According to an embodiment, a method performed by a base station in a communication system includes transmitting, on a serving cell, candidate cell configuration information on at least one candidate cell associated with inter radio access technology (RAT) handover, wherein the serving cell corresponds to a first RAT and the at least one candidate cell corresponds to a second RAT different from the first RAT and the candidate cell configuration information includes measurement configuration information associated with the at least one candidate cell and report configuration information associated with the at least one candidate cell; receiving, on the serving cell, a report for measurement associated with the candidate cell configuration information; identifying that the measurement is for the second RAT; and performing operations associated with the inter RAT handover.

Various embodiments of the disclosure described above are merely some of preferred embodiments of the disclosure, and many embodiments reflecting technical features of various embodiments of the disclosure may be derived and understood by those of ordinary skill in the art based on the detailed description provided below.

According to an embodiment of the disclosure, a network may support fast handover between RATs through simple structure enhancement. In addition, a terminal may perform fast handover between RATs without changing a communication modem.

Advantageous effects obtainable from the disclosure may not be limited to the above-mentioned effects, and other effects which are not mentioned may be clearly understood from the following descriptions by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of inter-RAT cooperation according to an embodiment of the disclosure;

FIG. 2 illustrates an example of inter-RAT cooperation according to an embodiment of the disclosure;

FIG. 3 illustrates an example of a terminal structure and layer cooperation according to an embodiment of the disclosure;

FIG. 4 illustrates an example of a handover operation according to an embodiment of the disclosure;

FIG. 5 illustrates an example of gradual handover according to an embodiment of the disclosure;

FIG. 6 illustrates an example of an inter-RAT handover procedure according to an embodiment of the disclosure;

FIG. 7 illustrates an example of a method in which a search for a target RAT is started according to an embodiment of the disclosure;

FIG. 8 illustrates an example of a method in which a search for a target RAT is started according to an embodiment of the disclosure;

FIG. 9 illustrates an example of a method in which a search for a target RAT is started according to an embodiment of the disclosure;

FIG. 10 illustrates an example of a method in which a search for a target RAT is started according to an embodiment of the disclosure;

FIG. 11 illustrates an example of inter-RAT event/condition configuration according to an embodiment of the disclosure;

FIG. 12 illustrates an example of inter-RAT event/condition configuration according to an embodiment of the disclosure;

FIG. 13 illustrates a structure of a UE according to an embodiment of the disclosure; and

FIG. 14 illustrates a structure of a base station according to an embodiment of the disclosure.

### DETAILED DESCRIPTION

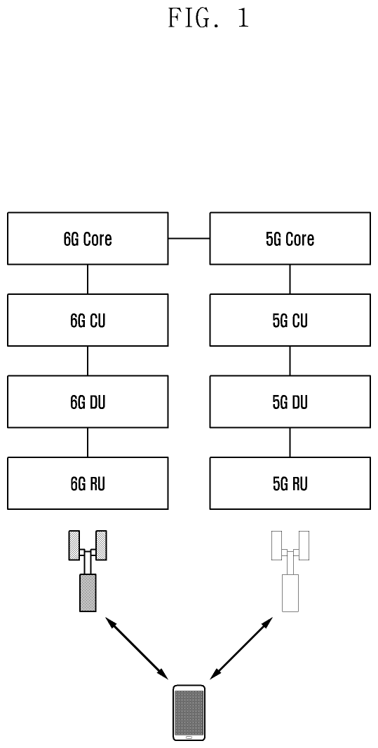

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be improved. Also, the data rate for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IOT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may cover a wider coverage than those of other services provided by the 5G communication system because the UEs are likely to be located in a shadow area, such as a basement of a building, which is not covered by the cell due to the nature of the service. The UE supporting mMTC must be configured to be inexpensive, and may support a very long battery lifetime such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also consider a packet error rate of 10⁻⁵ or less. Therefore, for the services supporting URLLC, a 5G system must provide a transmit time interval (TTI) shorter than those of other services, and also may consider a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, the term “a/b” may be understood as at least one of a and b.

Handover between cells or supporting terminal mobility is a core technology in mobile communication. As the number of nodes involved in handover increases or as the layers involved in control are higher, it is typical for the processing time and delay time for the handover to increase. Therefore, inter-RAT handover generally experiences the longest interruption time and other delay time among all mobility control situations. 5G has shown interruption time reductions and overall mobility improvements in some scenarios compared to 4G (4^{th} generation), but effective improvement methods for an inter-RAT environment have not yet been found.

The disclosure provides an improvement method for efficiently controlling mobility between 5G and 6G (5G-6G). The disclosure may be applied not only to mobility between 5G and 6G, but also to mobility between other RATs.

A terminal receiving a 6G service may be considered to provide a function of accessing a 5G network or 5G transceiver and performing communication, as an alternative, when it is not easy to access a 6G network or 6G transceiver, in addition to a function of accessing a 6G network and performing communication through the 6G network. This process of selecting and accessing, by a 6G terminal, a more suitable transceiver among a 6G transceiver (6G network) and a 5G transceiver (5G network) according to a communication environment is referred to as inter-5G-6G mobility. In a more general sense, such a series of process of selectively connecting, by a terminal, to transceivers (or networks) corresponding to different RAT systems is called inter-RAT mobility.

In a case where a commercial service begins in a situation where a specific RAT is unable to provide national coverage, inter-RAT mobility may be necessarily supported to provide a user with a stable usage environment (e.g., user experience), and a more advanced mobility management technique may be introduced according to RAT evolvement. For example, since 5G supports shorter interruption times compared to 4G, inter-RAT handover between 5G and 6G may support shorter interruption times compared to conventional inter-RAT handover between 4G and 5G.

Inter-RAT handover inevitably performs a cooperation between systems that manage different RATs. Depending on the supported degree of cooperation, the delay and signaling overhead for sharing measurement information and control information between RATs vary, and the implementation difficulty and cost of hardware/software (HW/SW) for system implementation also change.

When a new RAT system is implemented to share a core (e.g., including network functions or nodes) with a RAT system, as in a case of a 5G NSA (non-standalone) system, there is an advantage in reducing the initial implementation cost of the new RAT system. However, high control complexity may occur in the process of supporting two different RAT systems through a single core. Additionally, when inter-RAT cooperation occurs at a network unit close to a terminal, systems responsible for respective RATs perform lower-layer control through inter-RAT cooperation and thus control information and measurement data or user data may be shared between the RATs more frequently and with lower interface latency, thereby increasing the burden of system implementation.

To reduce the implementation burden as described above, the disclosure provides a technique of controlling mobility between 5G and 6G by granting some control authority for a 5G core to a 6G core.

Hereinafter, embodiments of the disclosure will be described in detail in conjunction with the accompanying drawings. As used herein, upper signaling (or upper layer signaling) is a method for transferring signals from a base station to a UE by using a downlink data channel of a physical layer, or from the UE to the base station by using an uplink data channel of the physical layer, and may also be referred to as “RRC signaling,” “PDCP signaling,” or “medium access control (MAC) control element (MAC CE).”

In the following description, a base station is an entity that allocates resources to terminals, and may be at least one of a gNode B, a gNB, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, upper layer signaling may refer to signaling corresponding to at least one signaling among the following signaling, or a combination of one or more thereof:
Master information block (MIB);
System information block (SIB) or SIB X (X=1, 2, . . . );
Radio resource control (RRC); and/or
Medium access control (MAC) control element (CE).

In addition, L1 signaling may refer to signaling corresponding to at least one signaling method among signaling methods using the following physical layer channels or signaling, or a combination of one or more thereof:
Physical downlink control channel (PDCCH);
Downlink control information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data);
Physical uplink control channel (PUCCH); and/or
Uplink control information (UCI).

Several embodiments described below in the disclosure are not independent of

each other, and one or more embodiments may be applied simultaneously or in combination.

FIG. 1 illustrates an example of inter-RAT cooperation according to an embodiment of the disclosure. FIG. 1illustrates an example of cooperation between a 6G network and a 5G network according to an embodiment of the disclosure.

An example of a cooperation technique provided in the disclosure is described with reference to FIG. 1. A 5G network is generally implemented/configured by four units including a 5G core, a 5G centralized unit (CU), a 5G distributed unit (DU), and a 5G radio unit (RU). Similarly, it is expected that a 6G network may be implemented/configured by a 6G core, a 6G CU, a 6G DU, and a 6G RU. This is an example and the disclosure is not limited thereto. According to some cases, some units among the units may be included in another unit. For example, a function handled by the 5G CU may be included in the 6G core so that the 6G network is configured by the 6G core, the 6G DU, and the 6G RU. In other words, a function of the 6G CU corresponding to the 5G CU may be included in the 6G core.

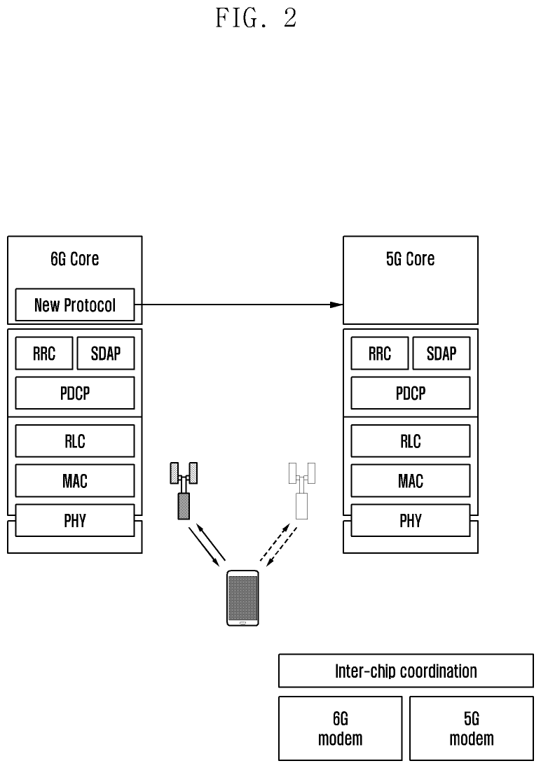

FIG. 2 illustrates an example of inter-RAT cooperation according to an embodiment of the disclosure. FIG. 2 illustrates an example of cooperation between a 6G network and a 5G network according to an embodiment of the disclosure.

FIG. 2 illustrates a core-part inter-RAT cooperation in units of protocol layers rather than a network unit.

A wireless protocol of a 5G network is configured by a service data adaptation protocol (SDAP), a packet data convergence protocol (PDCP), a radio link control (RLC), and a medium access control (MAC) at both a UE and an NR base station. A 6G network may also be configured by similar protocols, but this is an example and the disclosure is not limited thereto. For example, some protocols may be omitted or integrated with another protocol, or a new protocol may be defined.

The main functions of the SDAP may include some functions below:
Transfer of user plane data;
Mapping between a QoS flow and a DRB for both DL and UL;
Marking QoS flow ID in both DL and UL packets; and/or
Reflective QoS flow to DRB mapping for the UL SDAP PDUs.

With regard to the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QoS reflection configuration 1-bit indicator (NAS reflective QoS) and the AS QoS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the PDCP may include some functions below:
Header compression and decompression: ROHC only;
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and/or
Timer-based SDU discard in uplink.

The above-mentioned reordering of the NR PDCP device refers to a function of reordering PDCP PDUs received from a lower layer in an order based on the PDCP sequence number (SN), and may include a function of transferring data to an upper layer in the reordered sequence. Alternatively, the reordering of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

The main functions of the RLC may include some functions below:
Transfer of upper layer PDUs;
In-sequence delivery of upper layer PDUs;
Out-of-sequence delivery of upper layer PDUs;
Error Correction through ARQ;
Concatenation, segmentation and reassembly of RLC SDUs;
Re-segmentation of RLC data PDUs;
Reordering of RLC data PDUs;
Duplicate detection;
Protocol error detection;
RLC SDU discard; and/or
RLC re-establishment.

The above-mentioned in-sequence delivery of the NR RLC device refers to a function of delivering RLC SDUs, received from the lower layer, to the upper layer in sequence. The in-sequence delivery of the NR RLC device may include a function of, if one original RLC SDU is segmented into multiple RLC SDUs and the segmented RLC SDUs are received, reassembling the RLC SDUs and delivering the reassembled RLC SDUs, may include a function of reordering the received RLC PDUs with reference to the RLC sequence number (SN) or PDCP sequence number (SN), may include a function of recording RLC PDUs lost as a result of reordering, may include a function of reporting the state of the lost RLC PDUs to the transmitting side, and may include a function of requesting retransmission of the lost RLC PDUs. The in-sequence delivery of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all currently received RLC SDUs to the upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The above-mentioned out-of-sequence delivery of the NR RLC device refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The MAC may be connected to multiple NR RLC layer devices configured in one UE, and the main functions of the NR MAC may include some functions below:
Mapping between logical channels and transport channels;
Multiplexing/demultiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and/or
Padding.

A PHY layer may perform operations of channel-coding and modulating upper layer data, producing an orthogonal frequency-division multiplexing (OFDM) symbol therefrom and transmitting the same through a radio channel, or demodulating an OFDM symbol received through the radio channel, channel-decoding the same, and delivering the same to the upper layer.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure for each layer. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer.

In a 6G core, a new protocol other than the above protocols may be configured, defined, or used. The 6G core may define and use a new protocol to determine, when transferring/transmitting downlink 6G traffic generated through communication of a 6G UE or a 6G service to a destination UE, whether to process the traffic through a 6G RAT, whether to transfer same to a 5G RAT through a 5G core, or whether to transfer same to both systems supporting the two RATs, according to a network access state of the destination UE.

A UE capable of accessing both the 5G and 6G RATs provides to configure/include modems corresponding to the 5G RAT and 6G RAT, and fast inter-RAT handover compared to conventional handover may be supported through coordination/cooperation (inter-chip/inter-modem coordination/cooperation) between the 5G modem and 6G modem. The cooperation between the modems of the UE is implementable in various methods, and while the lower the layer protocol at which the cooperation is supported, the more precise the cooperation becomes, the difficulty in UE implementation rapidly increases.

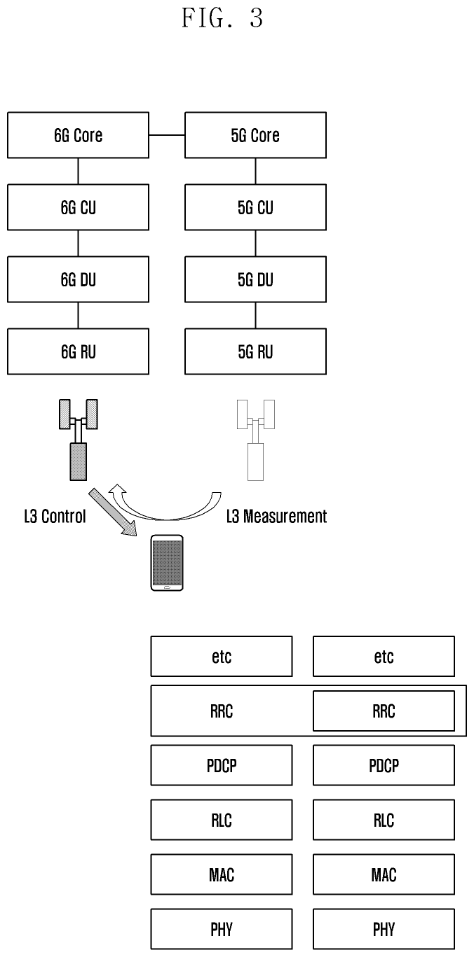

FIG. 3 illustrates an example of a UE structure and layer cooperation according to an embodiment of the disclosure.

The disclosure provides a UE structure that performs RRC configuration control of a 5G RAT through a 6G modem with respect to a 5G modem operating autonomously. The UE structure provided in the disclosure has an advantage in that the impact on the implementation of an 5G modem is minimized and control of a 5G RAT through a 6G RAT is possible.

In the disclosure, a 5G modem (and a modem responsible for a target RAT in the description of an embodiment of the disclosure described later) and a 6G modem (and a modem responsible for a serving RAT in the description of an embodiment of the disclosure described later) of a UE may be implemented by separate hardware (e.g., separate modems or separate transceivers). Alternatively, it may also be implemented that single hardware (e.g., a single modem or a single transceiver) functionally performs a 5G modem (and a modem responsible for a target RAT in the description of an embodiment of the disclosure described later) and a 6G modem (and a modem responsible for a serving RAT in the description of an embodiment of the disclosure described later).

For example, upper (higher) layer inter-RAT cooperation at a UE side may be performed. FIG. 3 illustrates an example of RRC cooperation, but the disclosure is not limited thereto. A 6G network may configure/control a 5G RRC through a 6G cell/link, and a 6G chip/modem may be a main controller at the UE side. A 6G RRC may control the 5G RRC at the UE side.

Through the above structure, a lower controller responsible for the 6G RAT, for example, a 6G DU and a 6G CU, are able to directly receive information on the link quality between the 5G RAT and the UE from the UE (layer 1 (L1) and layer 3 (L3) measurement) and may directly notify the UE of a configuration and a measurement indication (L1, L2, and L3 control) for inter-RAT mobility control, and handover decision may be also performed at the 6G DU/CU without cooperation with the 5G RAT. In this case, the handover decision is handled by the DU/CU, but a dualized operation handled by a 6G core is performed for user data flow according to the decision, and this is another feature of the disclosure.

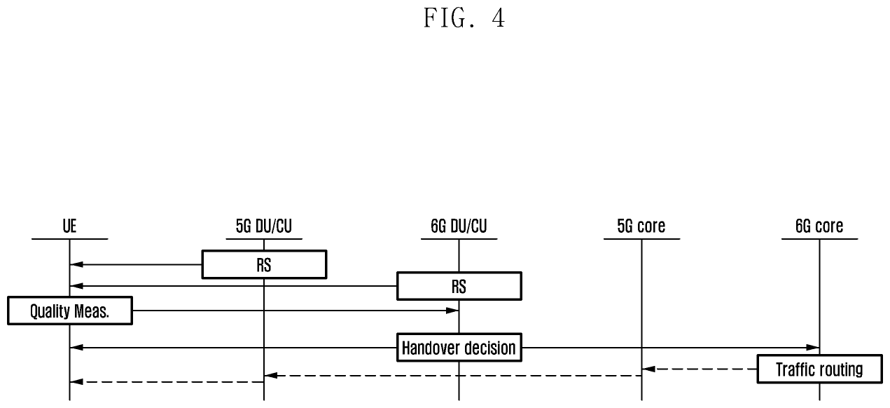

FIG. 4 illustrates an example of a handover operation according to an embodiment of the disclosure. FIG. 4 shows an example of the dualized handover operation.

Referring to FIG. 4, a 5G DU/CU and a 6G DU/CU may each transmit a reference signal to a UE, and the UE may perform a quality measurement therefor (e.g., this may be reference signal received power (RSRP), reference signal received quality (RSRQ), signal to noise ratio (SNR), signal to interference noise ratio (SINR), etc. and is not limited thereto) and report a quality measurement result to the 6G DU/CU. The 6G DU/CU may determine a handover, based on the quality measurement result and transmits same to a 6G core. The 6G core performs traffic routing and transfers user data to a 5G core. Thereafter, the 5G core transfers the user data to the UE through a 5G network lower part.

In designing an inter-RAT mobility control technique operating according to the above handover decision method and the above network and UE structure, the disclosure provides a gradual handover technique in which a UE goes through an intermediate stage of being connected to both two RATs before handover.

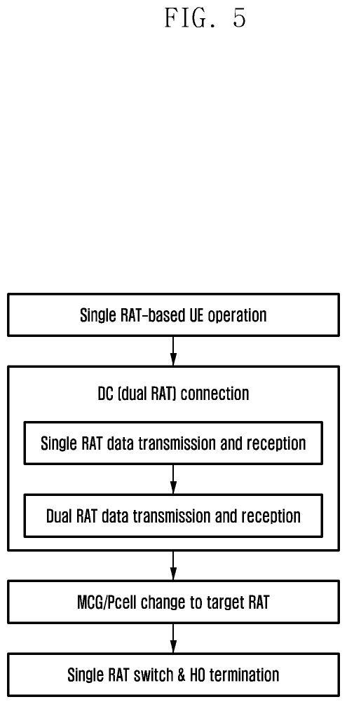

FIG. 5 illustrates an example of gradual handover according to an embodiment of the disclosure. When a UE operating based on a single RAT determines that inter-RAT handover is provided, the UE is first switched to a dual connection or dual RAT mode of being connected to both RATs. This is an operation falling under the broad concept of handover and, in the disclosure, it is referred to as early dual connectivity (early DC) for convenience of explanation.

The early DC stage (DC or dual RAT connection) is further classified into an environment of a single active RAT (or single active connection, single active cell/cell-group, or single RAT data transmission and reception) where the UE performs user data transmission and reception with one RAT, and a stage of a multi active RAT (or multi active connection, multi active cell/cell-group, or dual RAT data transmission and reception) where the UE performs at least one operation of user traffic reception or RS/channel transmission through two RATs. After going through the stage, the UE and a network performs a secondary handover stage of switching a cell or cell group selected in a target RAT into a main cell/cell-group. That is, a cell or cell group of a target RAT is changed to a main cell group (MCG)/primary cell (PCell). In the disclosure, for convenience of explanation, the corresponding stage is called main cell group (MCG) switching. As the last stage of gradual handover provided in the disclosure, the UE stops the dual connection/RAT mode and switches to a single RAT connection. Accordingly, an inter-RAT handover operation is completed.

Each of the stages provided as an example in FIG. 5 is triggered when a particular condition is satisfied or a particular event occurs. In each of the above stages, a condition or event for determining whether to proceed with the next stage or subsequent stage is defined or information for the defining is defined. In each of the above stages, a condition or event for stopping the corresponding stage and returning to the previous stage or stopping a handover operation is defined or information for the defining is defined. In addition, in each of the above stages, defining and transferring control information relating to measurement or reporting for determining whether the condition or event is satisfied, for example, RRC configuration, may be performed.

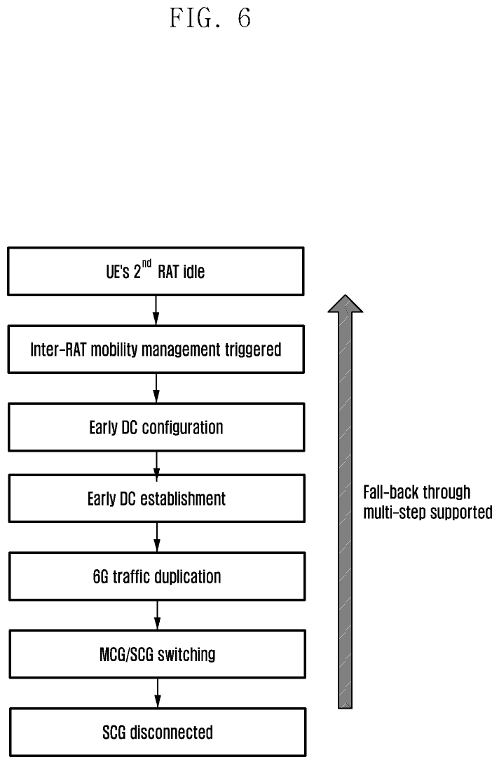

FIG. 6 illustrates an example of an inter-RAT handover procedure according to an embodiment of the disclosure.

An inter-RAT handover process according to an embodiment of the disclosure may include stages/operations provided as an example in FIG. 6. Hereinafter, in the description of an embodiment of the disclosure, a RAT to which a UE is connected during a handover and then transmits and receives user data is specified as a serving RAT, and a RAT to be subjected to inter-RAT handover of the UE is specified as a target RAT. It is also possible to describe the serving RAT as a lower network unit performing communication in the RAT, such as a serving cell of a RAT currently responsible for user data transmission and reception by the UE. The target RAT is also interpretable as a target cell in the same manner.

Before an inter-RAT mobility control technique according to an embodiment of the disclosure is started, a UE may be in a state of communicating with one RAT. That is, the UE may be in a state of using only a device of the UE functioning as communication with one RAT, for example, a modem corresponding to one RAT. That is, a device of the UE functioning as communication with another RAT, for example, a modem functioning as communication with another RAT may be turned off, and the UE may be, for the RAT, in a communication standby state where a series of preparation stages are performed before communication or in a stage where communication is unavailable, such as an RRC idle mode, an inactive mode, or a discontinuous reception (DRX) mode. A 2^{nd} RAT responsible unit or a 2^{nd} RAT of the UE or a model/chip for the 2^{nd} RAT may be idle (UE's 2^{nd} RAT idle).

As a first-stage operation of an inter-RAT handover according to an embodiment of the disclosure, the UE starts to perform measurement for the target RAT or support the measurement. Inter-RAT mobility management is triggered, and the UE starts to perform measurement for the target RAT or support the measurement. In the corresponding stage, the UE may specify a link quality for the target RAT, a link quality for cells definable as neighboring cells in the target RAT, or a link quality for each of cells measured through a cell detection stage in the target RAT or each of at least some of the cells and report the link quality to a network. Alternatively, the mentioned target RAT or cells of the target RAT perform uplink RS transmission to measure a link quality with the UE. When a condition to proceed with a second stage is not satisfied for a predetermined time, the UE may switch a modem responsible for the target RAT to an inactive mode again.

As a second-stage operation, the UE may be provided with information for performing measurement or initial access for the target RAT. The UE may be provided with a configuration (early DC configuration) for early DC. In the stage, the UE is provided with information on a candidate cell or candidate cell group to be subjected to the handover, and then performs measurement for the cell or cell group. A maximum number of configured candidate cells or candidate cell groups may be determined according to the capability of the UE, and in addition, the second stage may be omitted according to the UE capability. In addition, the second stage may not be supported according to a configuration of the target RAT or a cell configuration of the target RAT. In the corresponding stage operation, candidate cell and candidate cell group configuration is performed by information pre-secured by the network or reported by the UE in the first stage, the second stage is terminated when a condition to proceed with a third stage is not satisfied even after passage of a predetermined time after the second stage is performed, or when a second-stage termination condition is satisfied, the UE may proceed with an initial stage or be switched to the first stage according to a situation or condition, and in this case, the information on the candidate cell or candidate cell group configured in the corresponding stage is invalidated. For example, the UE may discard the same information.

As a third-stage operation, the UE generates a connection with the target RAT. The UE may establish early DCI (early DC establishment). In the corresponding process, the UE performs a connection to multiple cells corresponding to one group among the candidate cells or candidate cell groups configured in the second stage. In a case where the second stage is omitted, the UE selects a random cell in the target RAT and generates a connection with the target RAT. The selection may be performed by the UE or the serving RAT. In the corresponding stage, the UE continues communication through the serving RAT, serving cells, or an MCG, and the target RAT is connected to the UE in a form of additional connection, such as a second cell group (SCG), or a secondary cell (SCell). In the corresponding stage, the UE does not perform user data transmission and reception through the target RAT, and thus the connection with the target RAT may be described as being inactive. However, unlike a conventional inactive operation, in the corresponding stage, the UE may not perform user data transmission and reception with the target RAT, but perform reception and measurement of an RS through the target RAT, and according to defining of a UE capability, a UE supporting a relevant capability may receive an indication to transmit an uplink RS through the target RAT and perform same in the corresponding state. The indication may be provided through the serving RAT, and it is possible for some UEs to receive indication information from the target RAT according to a UE capability and network performance. Alternatively, when the UE performs a handover from a 5G RAT to a 6G RAT, that is, only when 6G is the target RAT, the UE may transmit an RS through the target RAT and receive control information for the RS transmission through the target RAT, and/or the UE being able to perform the corresponding operation may be defined through a UE capability. After early DC, the serving RAT may be called a 1^{st} RAT, a main RAT (M-RAT), a primary RAT (P-RAT), a main cell group (MCG), a primary cell (PCell), etc., and the target RAT may be called a 2^{nd} RAT, a secondary RAT (S-RAT), a secondary cell group (SCG), a secondary cell (SCell), etc. In the description of the following stages, an MCG and a SCG are used. When a condition to proceed with a fourth stage is not satisfied within a predetermined time after the third stage is performed, or when a condition corresponding to termination of the third stage is satisfied, the UE releases an SCG connection and performs one of the initial stage, the first stage, or the second stage according to a condition and a situation. Alternatively, the UE may be configured to maintain the corresponding stage until a particular condition is satisfied.

As a fourth-stage operation, the network transmits downlink user traffic to the UE through both the MCG and the SCG (6G traffic duplication). Uplink user data may be transmitted through one or both of the MCG and the SCG according to a UE capability, and when a separate UE capability is not defined, uplink user data may be transmitted through the MCG. When a condition to switch to a fifth stage is not satisfied within a predetermined time after the fourth stage is performed, or when a condition and an environment corresponding to stop of the fourth stage are satisfied, the UE stops performing the fourth stage. That is, the UE stops user data transmission and reception through the SCG. Thereafter, the UE falls back one of the initial stage or one of the first stage to the third stage.

As a fifth-stage operation, the UE and the network performs switching between the MCG and the SCG (MCG/SCG switching). The MCG is changed to the SCG, and the SCG is changed to the MCG. Accordingly, the 1^{st} RAT is changed to the 2^{nd} RAT, and the 2^{nd} RAT is changed to the 1^{st} RAT. After the changes, downlink user traffic is transmitted through only the MCG. Alternatively, according to a UE capability or a network configuration, user data may be transmitted through both the MCG and the SCG. When the transmission of downlink user data through the SCG is completed or stopped, the SCG is switched to an inactive mode, that is, a mode not supporting traffic transmission and reception, and the UE may only perform RS measurement through the SCG and not perform user data transmission and reception or control information transmission and reception. However, according to a UE capability and a network configuration and implementation, even when the SCG is inactive, transmission and reception of some control information through the SCG, transmission and reception of an uplink RS, or transmission and reception of some channels, for example, transmission and reception of a channel including pieces of information relating to a function or control of a network node such as cell specific information,

UE activation notification, cell de/activation information, etc., may be supported. When MCG/SCG rechange is determined within a predetermine time after switching between the MCG and the SCG is performed, the UE may repeat/perform the fifth stage again. That is, the MCG may be changed to the SCG again, and the SCG may be changed to the MCG again.

As a sixth-stage operation, the connection between the UE and the SCG is released (SCG disconnected). After the SCG release, the UE retains/stores a configuration on the SCG for a predetermined time. According to a situation and a condition, the UE may be switched to the fifth stage again, and the retained/stored information on the SCG is used for SCG link configuration. When the situation and the condition are not satisfied for a predetermined time, the UE terminates the sixth stage and all the handover process is completed.

Hereinafter, an inter-RAT handover method according to an embodiment of the disclosure is described in more detail.

In a first stage, a search for a target RAT may be triggered when a communication state between a UE and a serving RAT satisfies a particular condition. Alternatively, when a condition considering both a communication state between the UE and the serving RAT and a communication state between the UE and the target RAT is satisfied, the search may be triggered.

As an embodiment of a case of being triggered when a condition for the serving RAT is satisfied, the serving RAT may transfer, to the UE, a minimum condition for being a target cell or a candidate cell in the serving RAT. Thereafter, when a target cell or candidate cell search operation is triggered according to the necessity of handover of the UE, the UE performs a target/candidate cell search in the serving RAT. If the UE fails to find a target/candidate cell matching the minimum condition within a predetermined time or configured time, a search for a target RAT is started.

The minimum condition for being a target/candidate cell may include various parameters used for measurement of a link quality, such as least link quality, least RSRP, least RSRQ, least channel state information (CSI), etc., and may also include information on a time duration. The minimum condition for being a target/candidate cell may be defined based on at least one of the above parameters used for measurement of a link quality.

For example, as an example of the condition, a condition where a measured L3-RSRP value of a corresponding cell may be continuously equal to or greater than −80 dBm for a time of 10 ms in order for the cell to become a target/candidate cell in the serving RAT may be configured.

For example, the above condition may be configured to be a relative value. For example, a condition where a L1-RSRP measurement value of a corresponding cell may be continuously a value greater than L1-RSRP of a serving cell by 1 dB or greater for a period of 20 ms in order for the cell to become a target/candidate cell in the serving RAT may be configured.

A method in which a search for a target RAT is started may be various. For example, a search for a target RAT may be started by determination of the UE. Alternatively, a search may be started in a manner of determining, by the serving RAT, to start a search for a target RAT according to reporting by the UE and notifying the UE of the determination. Alternatively, a search for a target RAT may be started when the UE fails to report a proper cell within a predetermined time or a configured time after starting a target/candidate cell search in the serving RAT. As another example, a search may be started when the serving RAT indicates the UE to search for a target/candidate cell in the serving RAT and report same, but the UE fails to report corresponding information within a predetermined time or a configured time.

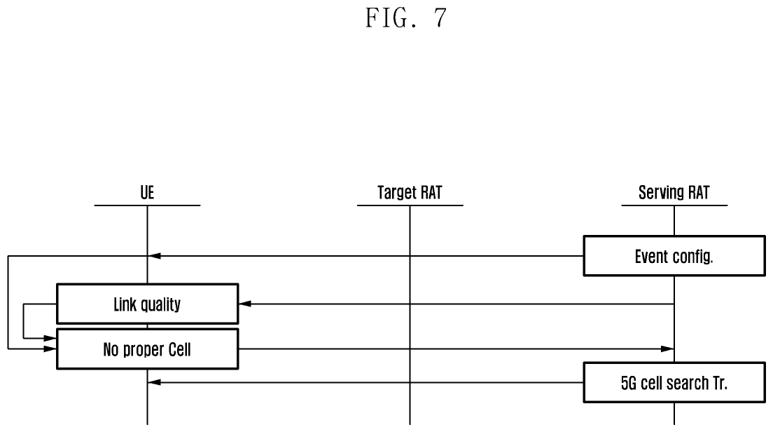

FIG. 7 illustrates an example of a method in which a search for a target RAT is started according to an embodiment of the disclosure.

In a case where the UE fails to report a proper cell within a predetermined time or a configured time after starting a target/candidate cell search in the serving RAT, or in a case where the serving RAT indicates the UE to search for a target/candidate cell in the serving RAT and report same, but the UE fails to report corresponding information within a predetermined time or a configured time, a search for a target RAT may be started. For example, a condition where a search for a target RAT is started may be configured according to an event configuration transmitted by the serving RAT to the UE.

The UE searches for a target/candidate cell in the serving RAT, based on measuring a link quality for the serving RAT. However, if a proper cell fails to be discovered and/or reported within a predetermined time or a configured time (i.e., an event is satisfied), the serving RAT may trigger the UE to search for a cell in a target RAT.

In addition, when a target RAT search is started by an indication from the serving RAT, the serving RAT transfers a corresponding command to the UE through RRC signaling or higher layer signaling, and the UE may apply the command to control of a modem responsible for the target RAT through an RRC-common controller. A detailed description thereof may be referenced to a description related to a UE structure and layer cooperation according to an embodiment of the disclosure described above.

As an embodiment of a case/condition where a target RAT search is triggered according to a condition considering both of the communication states of the serving RAT and the target RAT, a corresponding condition may be configured for the UE in a form of an event configuration. When the corresponding condition is satisfied by comparing a measurement result of a modem responsible for the target RAT, a measurement result of a modem responsible for the serving RAT, and the condition, the UE may report the condition being satisfied to the serving RAT. Thereafter, a target RAT search may be triggered by the serving RAT.

In the above example, the corresponding event may be configured such that the link quality of the target RAT is continuously higher than that of the serving RAT for a configured time. Alternatively, the event may be configured such that a link quality measured for a particular cell of the target RAT is continuously higher than the highest value among the link qualities of cells of the serving RAT for a configured time. That is, the event may be configured to be comparing a RAT-specific link quality or comparing a cell-specific link quality value of each RAT. Alternatively, the event may be also configured to be comparing a beam-specific link quality for each beam supported by each cell of each RAT. In addition, in the above comparison, information on a target RAT link quality may be one value lastly measured and reported, and information on a serving RAT link quality may be a value continuously measured and updated for a configured time.

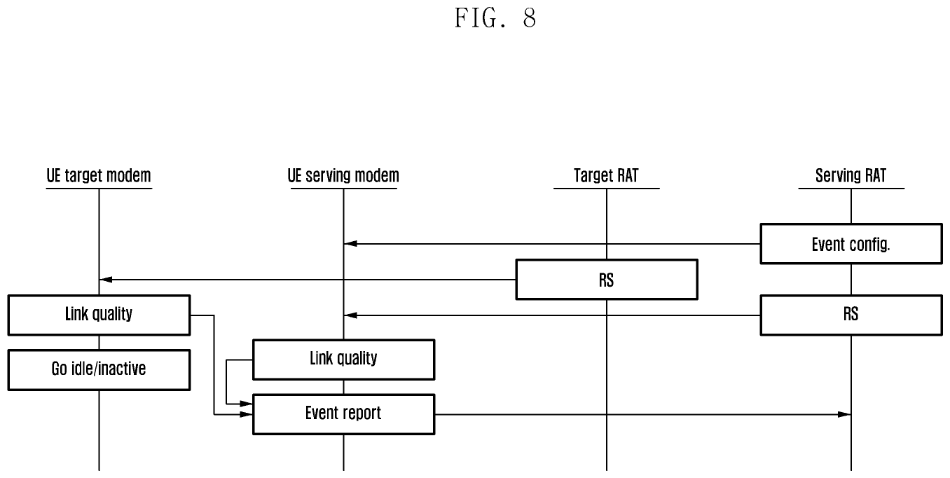

FIG. 8 illustrates an example of a method in which a search for a target RAT is started according to an embodiment of the disclosure.

The serving RAT may configure, for the UE, a condition considering both of the communication states of the serving RAT and a target RAT as an event configuration for a condition where a search for the target RAT is started. In this case, the UE may measure a link quality for an RS of the serving RAT and an RS of the target RAT and report same to the serving RAT. That is, when the corresponding condition is satisfied by comparing a measurement result of a modem responsible for the target RAT, a measurement result of a modem responsible for the serving RAT, and the condition, the UE may report the condition being satisfied to the serving RAT. Thereafter, a target RAT search may be triggered by the serving RAT. If the condition is not satisfied, the modem responsible for the target RAT may be switched to an idle/inactive state.

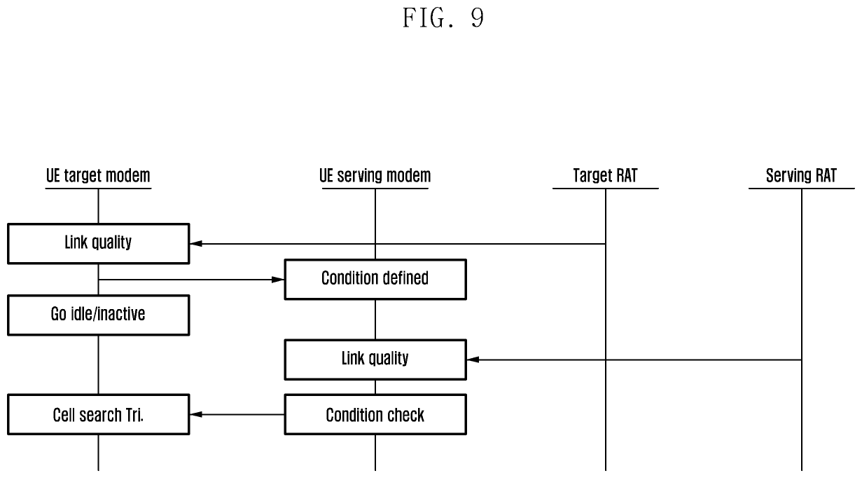

FIG. 9 illustrates an example of a method in which a search for a target RAT is started according to an embodiment of the disclosure.

As another embodiment for a case where a target RAT search is triggered according to a condition considering both of the communication states of the serving RAT and the target RAT, the UE may measure information on a link quality supportable at the time of access through the target RAT, through a modem responsible for the target RAT. That is, the UE may measure a link quality of a case of access through the target RAT, through a modem responsible for the target RAT before accessing the target RAT. The corresponding information is stored at a level of a controller controlling RRC between RATs, and accordingly, a condition for starting target RAT measurement is configured. A condition for starting target RAT measurement is configured based on the link quality.

Thereafter, the modem responsible for the target RAT is switched to a mode not performing user data transmission and reception or a mode restrictively performing same, such as an RRC idle mode, an inactive mode, etc. Thereafter, the UE measures a link quality providable by the serving RAT and determines whether to perform a search for the target RAT by comparing the link quality with a condition defined through target RAT measurement. That is, when the condition is satisfied, a search for the target RAT may be triggered.

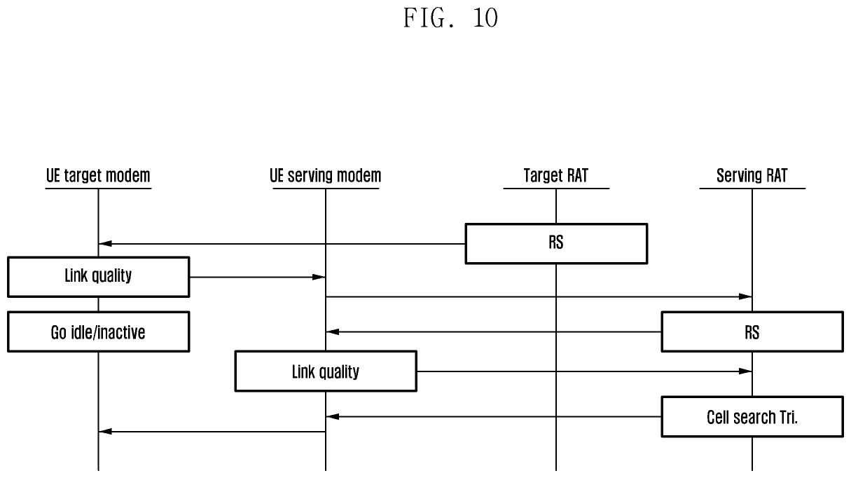

FIG. 10 illustrates an example of a method in which a search for a target RAT is started according to an embodiment of the disclosure.

FIG. 10 shows an example of a case where the UE reports a link quality for the target RAT and the serving RAT and the network triggers a target RAT search, based on the reporting.

The UE may measure information on a link quality supportable at the time of access through the target RAT, through a modem responsible for the target RAT, based on an RS of the target RAT. That is, the UE may measure a link quality of a case of access through the target RAT, through a modem responsible for the target RAT before accessing the target RAT. The measured link quality is reported to the serving RAT through a modem responsible for the serving RAT. Thereafter, the modem responsible for the target RAT is switched to a mode not performing user data transmission and reception or a mode restrictively performing same, such as an RRC idle mode, an inactive mode, etc.

The UE may measure a link quality providable by the serving RAT through the modem responsible for the serving RAT, based on an RS of the serving RAT, and report the link quality to the serving RAT. The serving RAT may trigger a search for the target RAT, based on the reported link quality for the target RAT and the link quality for the serving RAT.

In the above example, information on a target RAT link quality may be one value lastly measured and reported, and information on a serving RAT link quality may be a value continuously measured and updated for a configured time. That is, information on a target RAT link quality may be a value measured immediately before the modem responsible for the target RAT is switched to idle/inactive, and information on a serving RAT link quality may be a continuously measured value.

In the first stage, when a search for the target RAT is triggered, the UE may maintain the modem responsible for the RAT in an active state, measure a proper cell in the target RAT, and report same to the serving RAT. That is, the UE may report information on a measured cell and/or a measured result. For example, the UE may report information on a measured cell and/or a measured result when the UE is configured to report the information, but is not limited thereto. Alternatively, when the UE is not configured to report same, the UE may not report the measurement result. Alternatively, the UE may be configured to report only a part of the measurement result.

A report for the measurement may include cell ID information on a cell detected in the target RAT, and/or include information on a link quality securable through the cell and/or information on a link quality measured for the cell. In addition, the report for the measurement may include other information, such as information on a controller controlling the cell, for example, information on a DU controlling the cell, or when multiple cells are reported, may include information relating to whether the cells are controlled by the same controller, for example, the same DU. Alternatively, the UE reports information on a cell group controlled by the same controller. The information is reported through a channel and/or format capable of transferring higher layer information, such as a physical uplink shared channel (PUSCH). The serving RAT is able to allocate, to the UE, wireless resources used for reporting the information in a form of a scheduled PUSCH or a grant-free PUSCH.

In performing the target RAT search, the UE may obtain additional information for the search from the serving RAT and/or the target RAT. For example, the serving RAT may transfer, to the UE, information on a target RAT neighboring cell corresponding to a serving cell of the serving RAT in a form of RRC or MAC CE so as to configure the UE to perform a target RAT search only for the transferred neighboring cell or preferentially for the transferred neighboring cell. In another method, the serving RAT may transfer, to the UE, information on a cell capable of supporting an enhanced inter-RAT mobility technique provided in the disclosure among neighboring cells in the target RAT so as to indicate the UE requiring high-performance handover to perform a target RAT search preferentially for the cell.

In performing the above reporting, the UE may receive, through a configuration such as RRC or MAC CE, an indication to report some or all of various pieces of information, such as a cell ID, a cell group ID, a L1 link quality, or a L3 link quality, detected in the target RAT. The indication may be configured as common information for each RAT and/or information for each cell to be measured.

In addition, in reporting a result of a target RAT search, the UE may be configured or defined to report all discovered cells, or may be configured or defined to report cells satisfying a particular condition among the discovered cells, for example, a cell ensuring a link quality equal to or greater than a threshold, or n cells measured to have the best link quality among the discovered cells. According to the defining or configuring, the UE may not report a target RAT search result. The number of cells measured by the UE in the above operation, the number of reported cells, or the number of simultaneously reported cells may be configured by the network.

In performing a first-stage operation, in the following case, the UE may stop the target RAT search. When the UE is configured to report only a cell satisfying a particular condition and the UE fails to discover the cell within a configured or defined time, the UE may stop the first-stage operation. Alternatively, the UE may report the situation to the serving RAT to support the serving RAT to change the condition. That is, the UE may report, to the serving RAT, a case where discovering the cell within a configured or defined time fails, to support the serving RAT to change the condition. Thereafter, when the condition is changed and the changed condition is transferred to the UE in a form of RRC, MAC CE, or DCI (same may be indicated/transferred through one of RRC, MAC CE, or DCI or a combination of at least some), the UE resets a timer for measuring the configured or defined time and restart a target RAT search.

A condition for stopping the first-stage operation may be configured for the UE by the network. For example, if a link quality measured for a neighboring cell in the serving RAT is continuously superior to a link quality measured for cells in the target RAT within a defined or configured time interval (is continuously greater than the link quality), the UE may stop the target RAT search or be configured to stop same. Alternatively, the UE may stop the target RAT search by a direct indication from the network.

When the target RAT search is stopped by the above method, the UE is unable to report a target RAT search result anymore and/or may not report the same.

In performing the target RAT search described above, the UE may obtain additional information from the target RAT. For example, a cell in the target RAT may notify the UE of whether to support an enhancement inter-RAT mobility technique provided in the disclosure. In addition/alternatively, the cell may notify the UE of information on a cell group to which the cell belongs, for example, information on cells controlled by the same controller (e.g., DU or CU). Alternatively, the cell may notify the UE of more direct information on a controller, for example, a DU index, a CU index, and/or a cell group ID. The notification may be performed through cell specific information that is broadcast, may be performed through system information, and/or may be transmitted by a request from the UE.

A second-stage operation is triggered when a condition is satisfied. Whether the condition is satisfied is determined in the first stage.

As an embodiment, when the UE is configured to report corresponding information (e.g., the information on a link quality described above) in the first stage, the second stage may be triggered by the network. As an embodiment, when the UE is configured not to report corresponding information in the first stage, the UE assumes that the UE has been indicated to trigger the second stage according to autonomous determination. Alternatively, an operation of not reporting by the UE in the first stage and an operation of triggering the second stage by the UE may be simultaneously configured by a configuration of the same parameter. For example, a particular parameter may express two values, and when the parameter has a first value, this may indicate that the UE is indicated to report information on a link quality and at the same time, the UE is configured to be unable to trigger the second-stage operation. When the parameter has a second value, this may indicate that the UE is indicated not to report information on a link quality and the UE is configured to trigger the second-stage operation. Alternatively, a particular parameter may express three values, and when the parameter has a first value, this may indicate that the UE is indicated to report information on a link quality and at the same time, the UE is configured to be unable to trigger the second-stage operation. When the parameter has a second value, this may indicate that the UE is indicated to report information on a link quality and the UE is configured to be able to trigger the second-stage operation. When the parameter has a third value, this may indicate that the UE is indicated not to report information on a link quality and the UE is configured to be able to trigger the second-stage operation.

As a method of indicating trigger of the second stage by the network, the network may transfer, to the UE, corresponding information (information for performing measurement or initial access for the target RAT) in a method of RRC configuration without a separate indicator. That is, information for performing measurement or initial access for the target RAT being configured without an explicit indicator indicating trigger of the second stage may implicitly indicate that the second stage has been triggered. Alternatively, triggering of the second- stage operation is possible in a method of transferring corresponding information (information for performing measurement or initial access for the target RAT) in a method of RRC configuration first and then notifying that corresponding configuration information is used, through DCI or MAC CE.

Alternatively, when the corresponding operation is configured to be triggered by the UE, the UE may transfer configuration request information to the network for trigger of the second stage. The network may, when the configuration request information is received, transfer corresponding information (information for performing measurement or initial access for the target RAT) to the UE in a form of RRC configuration. Alternatively, when the UE has been configured to trigger the second stage and corresponding information (information for performing measurement or initial access for the target RAT) has already been configured for the UE, the UE may trigger the second stage and, simultaneously, report information to be applied by the UE among pre-configured pieces of information to the network. For example, the UE may report an index of information to be applied, to the network. Alternatively, when the UE notifies of trigger of the second stage, the network may transfer, to the UE as a response therefor, an indicator relating to which information may be applied among pre-configured pieces of information.

That is, an inter-RAT mobility configuration (corresponding to information for performing measurement or initial access for the target RAT) considered in the second stage may be configured by multiple independent sets and each set may be classified by an index indicating a corresponding set. The index may be indicated in a form of DCI, MAC CE, or UE reporting to notify of which set among the pre-configured sets is to be applied to subsequent inter-RAT mobility management. That is, an index corresponding to an inter-RAT mobility configuration to be actually applied (or activated) among multiple indexes may be indicated from the network and/or may be reported to the network by the UE. A set described above may be configured, for example, independently for each cell, independently for each cell group, independently for each beam, independently for each beam group, or independently for each TX/RX node.

Alternatively, a set described above may be defined according to a reception technique to be applied by the UE to search for each cell or receive a downlink signal of each cell. For example, each set may be indicated by an index that is configured for each wireless resource to be used by the UE to perform cell search or downlink reception of the cell and indicates the wireless resource. For example, a set described above may be configured for each PDDCH search space, each set of search spaces, or each control resource set (CORESET) used by the UE to detect downlink control information, and the application of a corresponding set may be indicated through an index indicating a corresponding wireless resource, for example, a CORESET index.

The above information (information for performing measurement or initial access for the target RAT) includes information designed or configured for supporting early DC of the UE. For example, the information may include information for determining early DC establishment, for example, information on candidate cells to be subjected early DC. In addition, the information may include information on a candidate cell group. In addition, the information may include information by the UE to measure a link quality for the cell or cell group. In addition, the information may include information on a method of reporting the measurement value.

For example, the above information (information for performing measurement or initial access for the target RAT) may include inter-RAT candidate cell configuration (candidate cell configuration) information. The candidate cell configuration information may include a mobility control technique supported by a corresponding cell, a transmission and reception technique supportable by the cell for a handover period, a transmission and reception technique of the UE indicated by the cell for a handover period, load information of the cell, a cell group ID to which the cell belongs, etc. In addition, the candidate cell configuration information may include information on a physical random access channel (PRACH) resource to be used by the UE when requesting a random access process to perform three-stage early DC.

Information on the mobility control technique supported by the corresponding cell may include information relating to whether the cell supports an enhanced inter-RAT mobility technique provided by the disclosure, whether the cell supports a handover command indicated by MAC CE or DCI, or whether the cell supports a mobility technique supported by other standards.

The transmission and reception technique supportable for a handover period may include each of information on a transmission and reception technique supported when a connection to a SCG is established during a handover process and user data transmission and reception is performed, and information on a transmission and reception technique supported when a connection to an MCG is established and user data transmission and reception is performed, respectively.

Information on the transmission and reception technique may include information on a supportable or configurable Tx or Rx mode, for example, information relating to whether a multi input multi output (MIMO) technique is supported or applied, whether a spatial multiplexing technique is applied, whether a diversity technique is applied, the number of layers simultaneously transmitted or received, a supported or configured measurement/reporting type, or a measurement/reporting resource type.

Information on the transmission and reception technique of the UE for a handover period may include a requirement for a delay time from the reception of control information to processing and application of the control information when the UE receives the control information from the corresponding cell, or a requirement for a delay time until necessary reporting is performed, and may include a requirement for a Tx mode or Rx mode which the UE may support. In addition, when the UE receives control information from the cell through DCI, MAC CE, or RRC and processes same, information relating to which layer, which channel, or which format involves control information reception to be supported, or which layer, which channel, or which format involves reporting to be supported.

For example, the above information (information for performing measurement or initial access for the target RAT) may include inter-RAT candidate cell group configuration (candidate cell group configuration) information. A candidate cell group configuration may include pieces of information listed in a candidate cell configuration described above or some of the pieces of information, and may be defined as group common information and transferred to the UE. That is, the information included in the candidate cell group configuration may be group common information for a corresponding cell group. The candidate cell group configuration may define and transfer information on one or multiple candidate cell groups, and may include information on identification or an ID of a cell belonging to each group. Alternatively, the candidate cell group configuration may include information on a controller (e.g., CU/DU) controlling each group.

For example, the above information (information for performing measurement or initial access for the target RAT) may include a measurement configuration and/or reporting configuration for an inter-RAT candidate cell or inter-RAT cell. Each of the measurement configuration and reporting configuration may be configured as a sub-configuration of a corresponding candidate cell configuration or cell group configuration, or may be configured as a separate configuration. In addition, it is also possible that at least some of the pieces of information listed in the candidate cell group configuration or an inter-RAT candidate cell described above is defined and transferred to the UE in a form of an inter-RAT measurement configuration or inter-RAT reporting configuration.

For example, the above information (information for performing measurement or initial access for the target RAT) may include information relating to whether UE measurement information on a candidate cell or candidate cell group is transferable to the network in a form of UE oriented/triggered reporting in supporting inter-RAT mobility. The UE oriented/triggered reporting may indicate an operation of determining, by the UE, a time point to perform reporting. When support of the operation is configured, the information includes information indicated by the UE to determine a time point to perform reporting. For example, a condition for the UE to perform the operation may be configured through the information.

After providing at least some of the above pieces of information, that is, pieces of information provided as an example in the description of the information for performing measurement or initial access for the target RAT, the UE may use the pieces of information in performing target RAT measurement or reporting. A target RAT measurement configuration indicated above may be different from a resource or reference signal used by the UE for a target RAT search in the first stage, and in this case, the UE may receive an additional indication relating to which of a reference used in the first stage and a reference configured in the second stage is to be used. Alternatively, both a reference used in the first stage and a reference configured in the second stage may be used. A reporting resource may be also different between a first-stage configuration and a second-stage configuration, and in this case, an additional indication relating to which resource or configuration is to be followed may be transferred to the UE. Alternatively, both a resource according to a first-stage configuration and a resource according to a second-stage configuration may be used. In addition, target RAT measurement by the second stage and target

RAT search work by the first stage may proceed simultaneously, or a first-stage search operation may be defined, configured, and indicated to be stopped simultaneously as the second stage begins.

A third-stage operation occurs when the second-stage operation is performed or the second-stage operation is omitted and an additional condition is satisfied. The additional condition may be configured/defined in a manner of indicating the three-stage operation by the network or recognizing, by the UE, that a pre-configured condition is satisfied. For trigger of the three-stage operation according to the additional condition, a new event for allowing the UE to perform reporting according to a particular condition may be defined, and/or a new condition where the UE determines trigger of the third stage may be defined.

The event and condition defined and configured for trigger of the third stage may be configured to have the same parameter as the event and condition used for trigger of the first and/or second stage and have the same or different values for each parameter, or may be configured to have different parameters.

In addition, the event and condition for trigger of the third stage may be defined or configured to be applied only when the first and/or second stage is performed, or may be defined or configured to be applied only when the event or condition defined or configured for trigger of the first and/or second stage is satisfied. That is, it may be defined or configured that whether the event and condition for trigger of the third stage are satisfied is determined only when the first and/or second stage is performed, and/or whether the event and condition for trigger of the third stage is satisfied is determined only when the event or condition defined or configured for trigger of the first and/or second stage is satisfied.

In addition, the event and condition for trigger of the third stage may be defined in a form of a value offset between a parameter configuring the event and condition and a parameter configuring the event or condition triggering the first and/or second stage. For example, if the condition triggering the second stage includes an L3-RSRP value for the target RAT and the value is −80 dBm, and the condition triggering the third stage includes an L3-RSRP value for the target RAT and the value is 3 dB, this implies that an increase of 3 dB from −80 dBm of the trigger condition of the second stage is used to trigger the third stage.

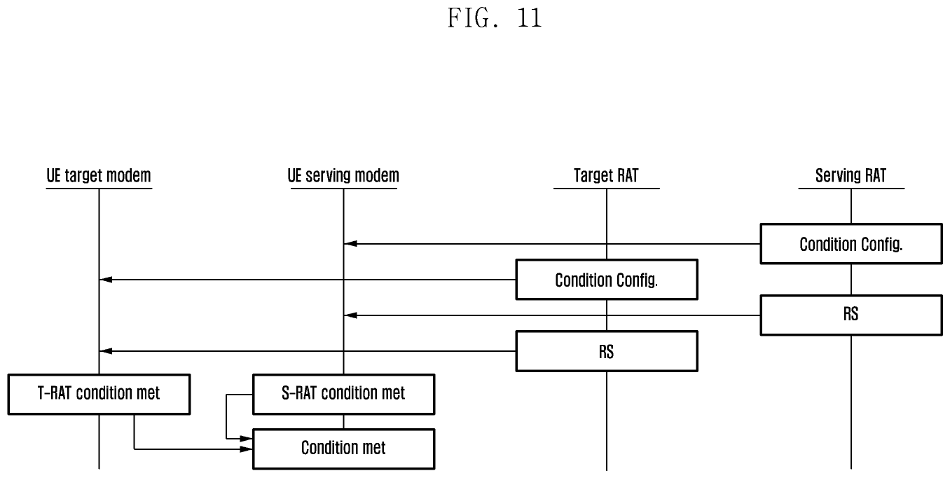

FIG. 11 illustrates an example of inter-RAT event/condition configuration according to an embodiment of the disclosure.

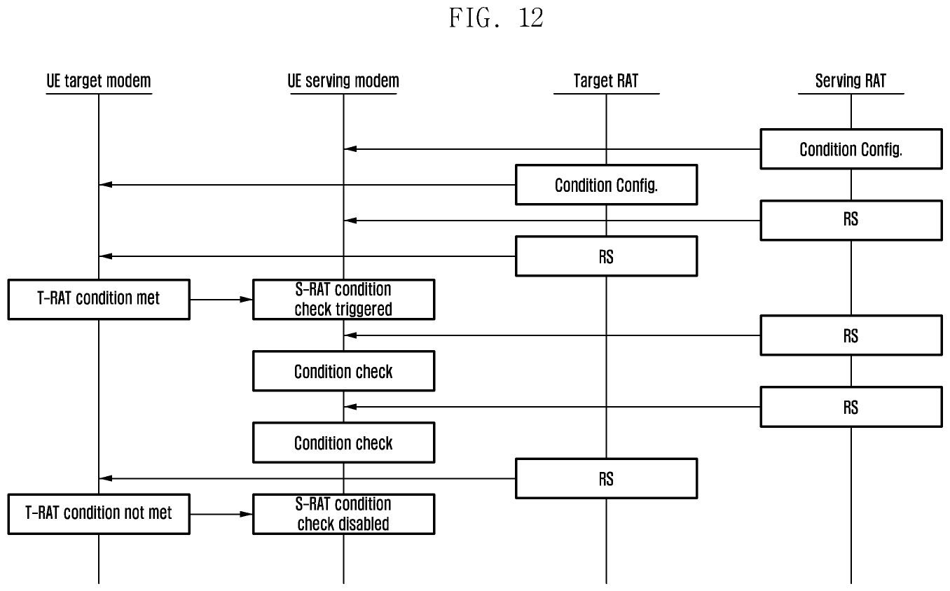

FIG. 12 illustrates an example of inter-RAT event/condition configuration according to an embodiment of the disclosure.

An operation of identifying whether an event or condition is satisfied for the serving RAT and the target RAT may be configured by two stages including an RAT-specific measurement and event/condition check stage and an inter-RAT check enabling signal stage. The UE is allocated a condition and/or event for each RAT, and may determine that an event or condition for the serving RAT and the target RAT condition is satisfied when the given conditions/events are satisfied for both of the RATs.

Referring to an example of inter-RAT event/condition configuration of FIG. 11, the UE inspects whether the event/condition for each RAT is satisfied, and when the event/condition is satisfied in both of the RATs, determines that the event/condition is satisfied. The UE may receive a condition/event configuration for the serving RAT through a modem responsible for the serving RAT, and receive a condition/event configuration for the target RAT through a modem responsible for the target RAT. The UE may measure an RS of the serving RAT through the modem responsible for the serving RAT, and measure an RS of the target RAT through the modem responsible for the target RAT. If the condition/event of the target RAT (T-RAT) is satisfied and the condition/event of the serving RAT (S-RAT) is satisfied according to each measurement, an inter-RAT condition/event being satisfied may be determined.

Referring to an example of inter-RAT event/condition configuration of FIG. 12, the UE may receive a condition/event configuration for the serving RAT through a modem responsible for the serving RAT, and receive a condition/event configuration for the target RAT through a modem responsible for the target RAT. The UE may measure an RS of the serving RAT through the modem responsible for the serving RAT, and measure an RS of the target RAT through the modem responsible for the target RAT. Whether the condition/event of the target RAT (T-RAT) is satisfied and whether the condition/event of the serving RAT (S-RAT) is satisfied may be determined according to each measurement.

The UE inspects whether the event/condition is satisfied for one of the serving RAT or the target RAT. Which RAT is to be inspected first may be pre-defined by a standard or may be indicated by the network. FIG. 12 shows an example of a case where event/condition inspection for the target RAT is performed first, but on the other hand, event/condition inspection for the serving RAT may be performed first.

The UE inspects whether the event/condition for the target RAT is satisfied, and then when the event/condition for the target RAT is satisfied, the UE inspects whether an event/condition associated with the satisfied event/condition for the target RAT and defined or configured for the serving RAT is satisfied. Thereafter, the target RAT inspects the satisfied event/condition for the target RAT or a condition for disabling the satisfied event/condition for the target RAT, and when the result indicates that the satisfied event/condition for the target RAT fails, inspection of whether a condition/event for the serving RAT associated therewith and defined or configured for the serving RAT is satisfied is stopped. That is, even when the satisfied event/condition for the target RAT is successful according to a corresponding condition inspection, an event/condition for the serving RAT may be satisfied for a valid period of the successful event/condition, for example, a predetermined or configured time, so as to determine an inter-RAT condition/event being satisfied.

In performing the third-stage operation, the UE establishes a connection with the target RAT. The above operation may be started by determining a target cell of the target RAT and performing, by the UE, PRACH transmission to the target cell. The UE may perform PRACH transmission according to an indication from the serving RAT as described above. Alternatively, if a pre-configured condition is satisfied, PRACH transmission may be performed according to determination by the UE. If PRACH resources are configured in the second stage, the UE selects one of the configured PRACH resources and performs PRACH transmission. If PRACH transmission is indicated through the serving RAT, the indication may indicate a resource to be used for the PRACH transmission. One or more target cells may be selected by or indicated to the UE for the target RAT according to a configuration and a UE capability. If two or more target cells are supported, the target cells may be cells belonging to the same candidate cell group configured in the second stage. If the serving RAT is 6G, the UE reports, to the serving RAT, that a random access procedure for the target RAT is completed. The report may include a target cell ID, information relating to whether a corresponding PRACH is for primary second cell (PSCell) (PCell in the target RAT) configuration, and information such as a candidate cell group index.

After the random access procedure, the UE switches an SCG to a de-active mode, and the UE transfers, to an SCG cell or special cell (SPcell), information indicating that switching to the de-active mode is completed.

A fourth-stage operation is triggered when the third-stage operation has been performed and the fourth-stage operation is indicated by the network. The network indicates the operation to the UE or notifies the UE of the operation according to a report from the UE or a request from the UE. When a pre-configured condition is satisfied, the UE may request the network to trigger the fourth-stage operation. Alternatively, the UE may perform reporting (a request for triggering) for the network according to a pre-configured event. The event and condition defined and configured for trigger of the fourth stage may be configured to have the same parameter as the event and condition used for trigger of the first, second, or third stage and have the same or different values for each parameter, or may be configured to have different parameters.

In addition, the event and condition for trigger of the fourth stage may be defined or configured to be applied only when the first, second, and/or third stage is performed, or may be defined or configured to be applied only when the event or condition defined or configured for trigger of the first, second, and/or third stage is satisfied. That is, it may be defined or configured that whether the event and condition for trigger of the fourth stage are satisfied is determined only when the first, second, and/or third stage is performed, and/or whether the event and condition for trigger of the fourth stage is satisfied is determined only when the event or condition defined or configured for trigger of the first, second, and/or third stage is satisfied.

In addition, the event and condition for trigger of the fourth stage may be defined in a form of a value offset between a parameter configuring the event and condition and a parameter configuring the event or condition triggering the first, second, and/or third stage.

If the fourth stage continues for a predetermined time or longer, the UE may request the network to stop the fourth stage. If the request is received, the network determines to proceed with a fifth stage or fall back to the previous stage (e.g., the first stage, the second stage, or the third stage), and notifies the UE of the determination.

A fifth-stage operation may also be triggered in the same method as the previous stage, an event or condition for starting the fifth stage may be defined or configured in the same method as the previous stages, and whether same is satisfied may be inspected in the same method as the previous stages. A method of triggering the fifth stage may be referenced to a method according to one of the first stage to the fourth stage.

As an example of a method of triggering a sixth stage, a sixth-stage trigger method of, when a singular point, for example, satisfaction of a fall back event/condition, does not occur for a predetermined time or configured time after the fifth stage is performed, proceeding with the sixth stage may be defined/configured. Alternatively, a new event/condition for trigger of the sixth stage may be defined, configured, and inspected in the same method as the above method. For more specific description, a description of the first stage to the fifth stage may be referenced, and a method according to one of the first stage to the fifth stage may be referenced.

An inter-RAT mobility control technique provided in the disclosure may be applied only when a UE performs a handover from a 6G network or 6G node to a 5G network/node, may be applied only when the UE performs a handover from a 5G network or 5G node to a 6G network/node, or may be applied in both of the cases.

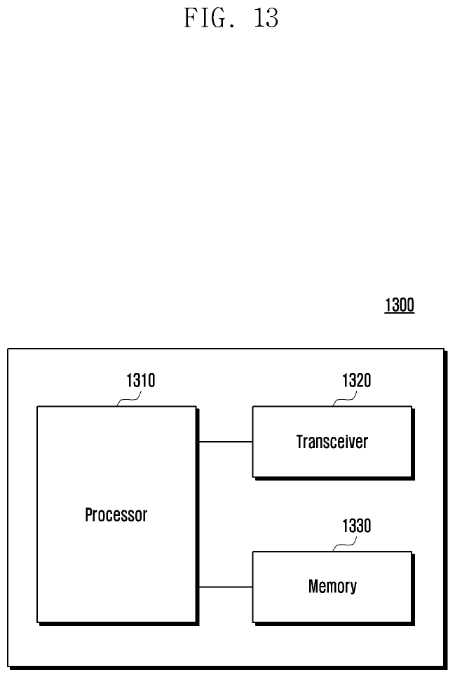

FIG. 13 illustrates a structure of a UE according to an embodiment of the disclosure.

Referring to FIG. 13, the UE 1300 may include a controller (e.g., processor) 1310, a transceiver 1320, and a memory (e.g., storage) 1330. As used herein, the controller may be defined as a circuit, an application specific integrated circuit, or at least one processor.

The controller 1310 may control the overall operation of the UE according to the embodiments provided in the disclosure. For example, the controller 1310 may control signal flows between the respective blocks to perform operations according to the above-described flowcharts. In addition, the above-described operations of the UE may be controller by the controller 1310.

The transceiver 1320 may transmit/receive signals with other network entities. The transceiver 1320 may be understood as the modem described above.

The memory 1330 may store at least one of information transmitted/received through the transceiver 1320 and information generated through the controller 1310.

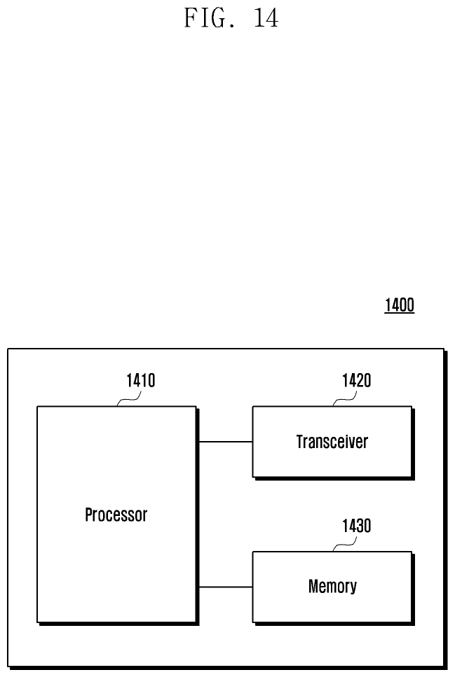

FIG. 14 illustrates a structure of a base station according to an embodiment of the disclosure.

Referring to FIG. 14, the base station 1400 may include a controller (e.g., processor) 1410, a transceiver 1420, and a memory (e.g., storage) 1430. As used herein, the controller may be defined as a circuit, an application specific integrated circuit, or at least one processor.

The controller 1410 may control the overall operation of the base station according to the embodiments provided in the disclosure. For example, the controller 1410 may control signal flows between the respective blocks to perform operations according to the above-described flowcharts. In addition, the above-described operations of the base station may be controlled by the controller 1410.

The transceiver 1420 may transmit/receive signals with other network entities.

The memory 1430 may store at least one of information transmitted/received through the transceiver 1420 and information generated through the controller 1410.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, other variants based on the technical idea of the embodiments may also be implemented in other communication systems such as FDD LTE, TDD LTE, 5G, or NR systems.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving, from a serving cell, candidate cell configuration information on at least one candidate cell associated with inter radio access technology (RAT) handover, wherein the serving cell corresponds to a first RAT and the at least one candidate cell corresponds to a second RAT different from the first RAT and the candidate cell configuration information includes measurement configuration information associated with the at least one candidate cell and report configuration information associated with the at least one candidate cell;
identifying that measurement for the second RAT is triggered;
performing the measurement based on the measurement configuration information;
transmitting, to the serving cell, a report for the measurement based on the report configuration information; and
performing operations associated with the inter RAT handover.

2. The method of claim 1, wherein the measurement is triggered:
from the serving cell based on an implicit indication corresponding to a first configuration being received or (ii) an explicit indication to trigger the measurement being received from the serving cell, or
by the UE autonomously in case that a second configuration to allow the UE to trigger the measurement autonomously is received from the serving cell.

3. The method of claim 1, wherein the receiving the candidate cell configuration information, the identifying that measurement for the second RAT is triggered, the performing the measurement, and the transmitting the report is in an operation among a plurality of operations associated with the inter RAT handover,
wherein in case that one of first predetermined conditions to perform a next operation is satisfied during an operation, the UE performs the next operation,
wherein in case that one of second predetermined conditions to perform a previous operation is satisfied during an operation, the UE performs the previous operation,
wherein the first predetermined conditions are defined for each operation and include: a radio resource control (RRC) configuration is received, an explicit indication to perform the next operation is received, and the UE determines to perform the next operation based on a configured condition, and
wherein the second predetermined conditions are defined for each operation and include: a timer configured for an operation is expired.

4. The method of claim 3, wherein the plurality of operations includes:
performing searching a target RAT for the inter RAT handover in case that a first predetermined condition to perform searching the target RAT is satisfied;
after transmitting the report, establishing dual connectivity (DC) for a master cell group (MCG) corresponding to the first RAT and a secondary cell group (SCG) corresponding to the second RAT in case that a first predetermined condition to perform the establishing the DC is satisfied, wherein the SCG corresponding to the second RAT includes a candidate cell;
performing communication in case that a first predetermined condition to perform the communication is satisfied;
switching the MCG corresponding to the first RAT to an SCG corresponding to the first RAT and the SCG corresponding to the second RAT to an MCG corresponding to the second RAT in case that a first predetermined condition to switch is satisfied; and
releasing the SCG corresponding to the first RAT in case that a first predetermined condition to release the SCG is satisfied.

5. The method of claim 4, wherein the communication includes reception of downlink user data duplicated on the MCG corresponding to the first RAT and the SCG corresponding to the second RAT, and
wherein downlink user data is received on the MCG corresponding to the second RAT and not received on the SCG corresponding to the first RAT after the switching.

6. The method of claim 4, wherein after the DC is established, the SCG corresponding to the second RAT is inactive, before performing the communication, wherein:
user data is not communicated on the inactive SCG corresponding to the second RAT;
a downlink reference signal (RS) is available to be received on the inactive SCG corresponding to the second RAT; and
an uplink RS is available to be transmitted on the inactive SCG corresponding to the second RAT subject to a UE capability in case that an indication to transmit the uplink RS on the inactive SCG corresponding to the second RAT is received or in case that the first RAT corresponds to a 5th generation (5G) technology and the second RAT corresponds to a 6G technology.

7. The method of claim 4, wherein in case that a second predetermined condition for the operation including the receiving the candidate cell configuration information, the identifying that measurement for the second RAT is triggered, the performing the measurement, and the transmitting the report is satisfied, the candidate cell configuration information is terminated and the UE fallbacks to perform searching the target RAT,
wherein in case that a second predetermined condition for the establishing the DC is satisfied, the UE fallbacks to perform one of searching the target RAT or the operation including the receiving the candidate cell configuration information, the identifying that measurement for the second RAT is triggered, the performing the measurement, and the transmitting the report,
wherein in case that a second predetermined condition for the performing the communication is satisfied, the UE fallbacks to perform one of searching the target RAT, the operation including the receiving the candidate cell configuration information, the identifying that measurement for the second RAT is triggered, the performing the measurement, and the transmitting the report, or the establishing the DC,
wherein in case that a second predetermined condition for the switching is satisfied, the UE fallbacks to perform one of searching the target RAT, the operation including the receiving the candidate cell configuration information, the identifying that measurement for the second RAT is triggered, the performing the measurement, and the transmitting the report, the establishing the DC, or the performing the communication, and
wherein in case that a second predetermined condition for the releasing is satisfied, the UE fallbacks to perform one of searching the target RAT, the operation including the receiving the candidate cell configuration information, the identifying that measurement for the second RAT is triggered, the performing the measurement, and the transmitting the report, the establishing the DC, the performing the communication, or the switching.

8. The method of claim 3, wherein at least one of the first predetermined conditions corresponds to link quality for at least one of the first RAT, the second RAT, the target RAT, or a

9. A user equipment (UE) in a communication system, the UE comprising:
a transceiver; and
a processor coupled with the processor and configured to:
receive, from a serving cell, candidate cell configuration information on at least one candidate cell associated with inter radio access technology (RAT) handover, wherein the serving cell corresponds to a first RAT and the at least one candidate cell corresponds to a second RAT different from the first RAT and the candidate cell configuration information includes measurement configuration information associated with the at least one candidate cell and report configuration information associated with the at least one candidate cell;
identify that measurement for the second RAT is triggered;
perform the measurement based on the measurement configuration information;
transmit, to the serving cell, a report for the measurement based on the report configuration information; and
perform operations associated with the inter RAT handover.

10. The UE of claim 9, wherein the measurement is triggered:
from the serving cell based on an implicit indication corresponding to a first configuration being received or (ii) an explicit indication to trigger the measurement being received from the serving cell, or
by the UE autonomously in case that a second configuration to allow the UE to trigger the measurement autonomously is received from the serving cell.

11. The UE of claim 9, wherein the receiving the candidate cell configuration information, the identifying that measurement for the second RAT is triggered, the performing the measurement, and the transmitting the report is in an operation among a plurality of operations associated with the inter RAT handover,
wherein in case that one of first predetermined conditions to perform a next operation is satisfied during an operation, the UE performs the next operation,
wherein in case that one of second predetermined conditions to perform a previous operation is satisfied during an operation, the UE performs the previous operation,
wherein the first predetermined conditions are defined for each operation and include: a radio resource control (RRC) configuration is received, an explicit indication to perform the next operation is received, and the UE determines to perform the next operation based on a configured condition, and
wherein the second predetermined conditions are defined for each operation and include:
a timer configured for an operation is expired.

12. The UE of claim 11, wherein the plurality of operations includes:
performing searching a target RAT for the inter RAT handover in case that a first predetermined condition to perform searching the target RAT is satisfied;
after transmitting the report, establishing dual connectivity (DC) for a master cell group (MCG) corresponding to the first RAT and a secondary cell group (SCG) corresponding to the second RAT in case that a first predetermined condition to perform the establishing the DC is satisfied, wherein the SCG corresponding to the second RAT includes a candidate cell;
performing communication in case that a first predetermined condition to perform the communication is satisfied;
switching the MCG corresponding to the first RAT to an SCG corresponding to the first RAT and the SCG corresponding to the second RAT to an MCG corresponding to the second RAT in case that a first predetermined condition to switch is satisfied; and
releasing the SCG corresponding to the first RAT in case that a first predetermined condition to release the SCG is satisfied.

13. The UE of claim 12, wherein the communication includes reception of downlink user data duplicated on the MCG corresponding to the first RAT and the SCG corresponding to the second RAT, and
wherein downlink user data is received on the MCG corresponding to the second RAT and not received on the SCG corresponding to the first RAT after the switching.

14. The UE of claim 12, wherein after the DC is established, the SCG corresponding to the second RAT is inactive, before performing the communication, wherein:
user data is not communicated on the inactive SCG corresponding to the second RAT;
a downlink reference signal (RS) is available to be received on the inactive SCG corresponding to the second RAT; and
an uplink RS is available to be transmitted on the inactive SCG corresponding to the second RAT subject to a UE capability in case that an indication to transmit the uplink RS on the inactive SCG corresponding to the second RAT is received or in case that the first RAT corresponds to a 5th generation (5G) technology and the second RAT corresponds to a 6G technology.

15. The UE of claim 12, wherein in case that a second predetermined condition for the operation including the receiving the candidate cell configuration information, the identifying that measurement for the second RAT is triggered, the performing the measurement, and the transmitting the report is satisfied, the candidate cell configuration information is terminated and the UE fallbacks to perform searching the target RAT,
wherein in case that a second predetermined condition for the establishing the DC is satisfied, the UE fallbacks to perform one of searching the target RAT or the operation including the receiving the candidate cell configuration information, the identifying that measurement for the second RAT is triggered, the performing the measurement, and the transmitting the report,
wherein in case that a second predetermined condition for the performing the communication is satisfied, the UE fallbacks to perform one of searching the target RAT, the operation including the receiving the candidate cell configuration information, the identifying that measurement for the second RAT is triggered, the performing the measurement, and the transmitting the report, or the establishing the DC,
wherein in case that a second predetermined condition for the switching is satisfied, the UE fallbacks to perform one of searching the target RAT, the operation including the receiving the candidate cell configuration information, the identifying that measurement for the second RAT is triggered, the performing the measurement, and the transmitting the report, the establishing the DC, or the performing the communication, and
wherein in case that a second predetermined condition for the releasing is satisfied, the UE fallbacks to perform one of searching the target RAT, the operation including the receiving the candidate cell configuration information, the identifying that measurement for the second RAT is triggered, the performing the measurement, and the transmitting the report, the establishing the DC, the performing the communication, or the switching.

16. The UE of claim 11, wherein at least one of the first predetermined conditions corresponds to link quality for at least one of the first RAT, the second RAT, the target RAT, or a

17. A method performed by a base station in a communication system, the method comprising:
transmitting, on a serving cell, candidate cell configuration information on at least one candidate cell associated with inter radio access technology (RAT) handover, wherein the serving cell corresponds to a first RAT and the at least one candidate cell corresponds to a second RAT different from the first RAT and the candidate cell configuration information includes measurement configuration information associated with the at least one candidate cell and report configuration information associated with the at least one candidate cell;
receiving, on the serving cell, a report for measurement associated with the candidate cell configuration information;
identifying that the measurement is for the second RAT; and
performing operations associated with the inter RAT handover.

18. A base station in a communication system, the base station comprising:
a transceiver; and
a processor coupled with the transceiver and configured to:
transmit, on a serving cell, candidate cell configuration information on at least one candidate cell associated with inter radio access technology (RAT) handover, wherein the serving cell corresponds to a first RAT and the at least one candidate cell corresponds to a second RAT different from the first RAT and the candidate cell configuration information includes measurement configuration information associated with the at least one candidate cell and report configuration information associated with the at least one candidate cell;
receive, on the serving cell, a report for measurement associated with the candidate cell configuration information;
identify that the measurement is for the second RAT; and
perform operations associated with the inter RAT handover.
